(19) United States
(12) Patent Application Publication
(10) Pub. No.: US 2016/0139699 A1
(43) Pub. Date: May 19, 2016

(54) LIGHT SENSITIVE DIGITIZER SYSTEM

(71) Applicant: Microsoft Technology Licensing, LLC, Redmond, WA (US)

(72) Inventor: Eliyahu BAREL, Beit-Aryeh (IL)

(21) Appl. No.: 14/941,612

(22) Filed: Nov. 15, 2015

Related U.S. Application Data
(60) Provisional application No. 62/080,341, filed on Nov. 16, 2014.

(51) Int. Cl. G06F 3/042; G06F 3/044

(52) U.S. Cl. CPC G06F 3/042; G06F 3/044; G06F 2203/04106; G06F 2203/04107; G06F 2203/04104

(57) ABSTRACT

A digitizer sensor includes a plurality of antennas defining a grid of junctions and light sensitive material configured to affect capacitive coupling at one or more junctions based on exposure to a beam projected on the digitizer sensor. The plurality of antennas of the digitizer sensor is configured to sense capacitive coupling at the junctions.

### RELATED APPLICATION

This application claims the benefit of priority under 35 USC §119(e) of U.S. Provisional Patent Application No. 62/080,341 filed on Nov. 16, 2014, the contents of which are incorporated herein by reference in their entirety.

### BACKGROUND

Digitizing systems that allow a user to operate a computing device at close range with a stylus and/or finger are known. Typically, a digitizer system includes a digitizer sensor that is integrated with a display screen, e.g., over-laid on the display screen of the computing devices. The detected position of the stylus and/or conductive object, such as a finger or another body part, provides input to the computing device associated with the display, and is interpreted by the computing device as user commands. Input is detected while the stylus and/or conductive object is touching or hovering over the digitizer sensor. Some styluses provide input by transmitting a signal that is picked up by the digitizer sensor at a location proximal to a writing tip of the stylus. Examples of computing devices with digitizer systems include tablets, pen enabled laptop computers, or hand held device such as smart-phones.

Some digitizer systems operate with a capacitive based digitizer sensor. Capacitive based digitizer sensors include electrodes that can be constructed from different media, such as copper, Indium Tin Oxide (ITO) and printed ink. ITO is typically used to achieve transparency. Some capacitive based digitizer sensors are grid based and are operated to detect mutual capacitance between the electrodes at different points in the grid.

### SUMMARY

According to an aspect of some embodiments of the present disclosure there is provided a capacitive based digitizer sensor that can detect a track beam of light projected on the sensor, e.g. infrared (IR) radiation. Optionally, the beam is projected from a distance of up to a few meters from the digitizer sensor, e.g. with a remote control or laser pointer. In one example, a laser pointer can select and move virtual objects displayed on a touch enabled screen from a distance. Alternatively, the beam may be projected at close range, e.g. with a stylus interacting with the digitizer sensor by hover and touch. The same digitizer sensor is also sensitive to finger touch input, to input by objects having conductive or dielectric properties as well as input from a stylus that emits a signal.

Unless otherwise defined, all technical and/or scientific terms used herein have the same meaning as commonly understood by one of ordinary skill in the art. Although methods and materials similar or equivalent to those described herein can be used in the practice or testing of embodiments of the disclosure, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the disclosure are herein described, by way of example only, with reference to the accompanying drawings. With specific reference now to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

In the drawings:

FIG. 1 is a simplified schematic drawing of a touch-screen in accordance with some embodiments of the present disclosure;

FIG. 2 is a simplified schematic drawing of a digitizer sensor including light sensitive material at junction areas between row and column conductive strips in accordance with some embodiments of the present disclosure;

FIG. 3 is a simplified schematic drawing of a digitizer sensor including a layer of light sensitive material in accordance with some embodiments of the present disclosure;

FIGS. 4A and 4B are simplified schematic drawings of a digitizer sensor including light sensitive material applied under bridges of the digitizer sensor and a detailed blow up of a bridge area respectively in accordance with some embodiments of the present disclosure;

FIGS. 5A and 5B are simplified schematic cross sections cut along a column and a row direction respectively of a double layer digitizer sensor in accordance with to some exemplary embodiments of the present disclosure;

FIGS. 6A, 6B, 6C, 6D, 6E and 6F are simplified schematic drawings of exemplary sensor stack in accordance with some embodiments of the present disclosure;

FIG. 7 is simplified schematic drawing of exemplary devices for projecting a beam that can be tracked by a digitizer sensor in accordance with some exemplary embodiments of the present disclosure;

FIGS. 8A and 8B are graphs of exemplary modulated light signal imposed on a digitizer sensor and corresponding output detected in accordance with some embodiments of the present disclosure; and

FIG. 9 is a simplified schematic drawing of a touch enabled computing device in accordance with some embodiments of the present disclosure.

### DETAILED DESCRIPTION

According to some embodiments of the present disclosure, light sensitive material is integrated into a capacitive based digitizer sensor. The light sensitive material is configured to alter capacitive coupling between sensing elements of a capacitive based digitizer sensor at a location(s) that is radiated. The light sensitive material may alternatively be configured to alter resistance of a resistive-based digitizer or may introduce a resistive path to a capacitive based digitizer sensor. Typically, the sensitivity of the material is for a defined range of wavelengths, e.g. IR range that can be distinguished from ambient light.

Typically, the change in capacitive coupling or resistance that occurs in response to light exposure is detected by circuitry associated with the digitizer sensor. In some exemplary embodiments, output detected in response to light exposure is differentiated from output detected from other interaction, e.g. finger touch interaction and conductive object interaction. In some exemplary embodiments, the input provided by the light source is encoded and the circuitry associated with the digitizer sensor decodes information encoded.

The light sensitive material may be a photoconductive material that alters resistivity when exposed or photovoltaic material that generates a potential when exposed. Optionally, a photodiode is used to sense beam projected on the digitizer sensor. In some exemplary embodiments, the light sensitive material is transparent.

The light sensitive material can be applied as a layer covering the digitizer sensor or can be dispersed around the sensor, e.g. positioned in junction areas of a grid based capacitive sensor. Different configurations can be applied for integrating the light sensitive material with a digitizer sensor formed on a single layer, a digitizer sensor including ITO on a single layer and bridges and a digitizer sensor including two sensing layers, e.g. a separate row layer and column layer.

In some exemplary embodiments, photovoltaic material is integrated on the digitizer sensor for accumulating charge for powering the computing device with the digitizer sensor. Optionally, the light sensitive material applied for accumulating charge for powering the computing device is selected to be sensitive to ambient light and is other or added in addition to light sensitive material applied to detect interaction based on radiation input.

Exemplary light sensitive material that may be applied includes Lead sulfide (PbS), Lead selenide (PbSe), Indium antimonide (InSb), Mercury cadmium telluride (MCT,HgCdTe), Mercury zinc telluride (MZT, HgZnTe), Mercury cadmium telluride (MCT,HgCdTe), Indium antimonide (InSb), Cadmium sulphide (CdS), Indium antimonide (InSb), Indium gallium arsenide (InGaAs), Germanium, Indium arsenide (InAs), Platinum silicide (PtSi), or other material. Transparency of the material may be achieved by using carbon nanotube technology with quantum dots. In some exemplary embodiments, the response time for the photoconductive material may range between 0.2 msec to 10 msec, while the response times for the photovotalic or photodiode material is typically shorter.

Before explaining at least one embodiment of the exemplary embodiments in detail, it is to be understood that the disclosure is not necessarily limited in its application to the details of construction and the arrangement of the components and/or methods set forth in the following description and/or illustrated in the drawings and/or the Examples. The disclosure is capable of other embodiments or of being practiced or carried out in various ways.

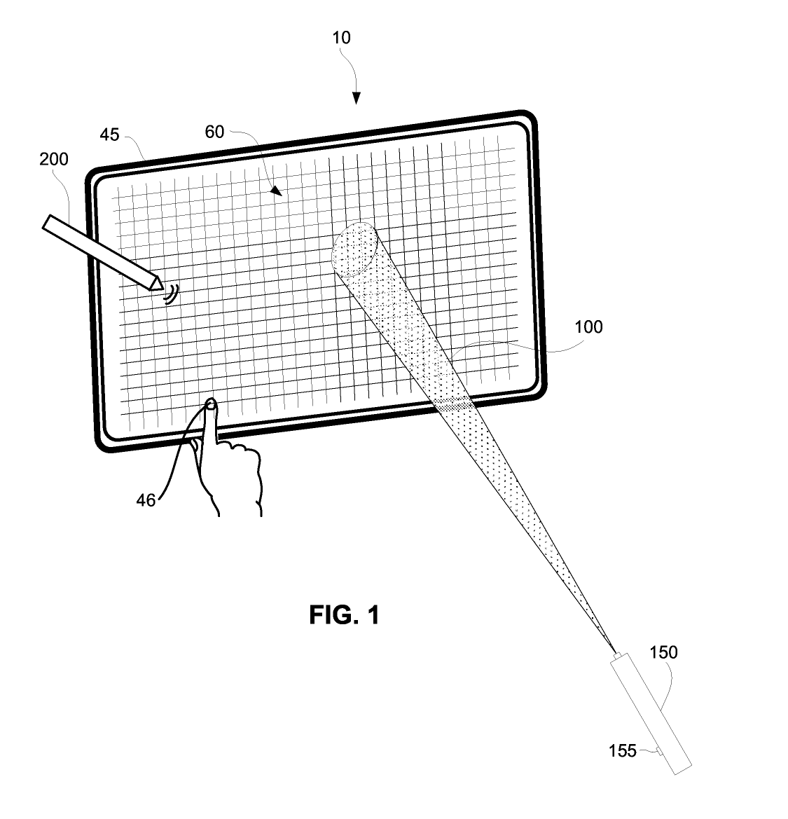

Reference is now made to FIG. 1 showing a simplified schematic drawing of a touch-screen in accordance with some embodiments of the present disclosure. Typically, a touch-screen 10 includes a digitizer sensor 60 integrated on a display 45. The digitizer may be integrated with display 45 by bonding the digitizer onto a display stack, or by using out cell, on cell, or in cell digitizer technologies in which to the digitizing elements shared circuits within display 45. Display 45 is typically a flat panel display (FPD) used in laptop computers, tables, smart-phones, monitors for personal computers and television screens. Digitizer sensor 60 is typically a grid based capacitive sensor that is integrated with light sensitive material.

According to some exemplary embodiments, a touch-screen 10 detects and tracks touch and hover of a fingertip 46, a signal emitting stylus 200 and also a beam 100 projected by a beam generator 150 on touch-screen 10. Stylus 200 typically emits a signal in the form of an electric field from its writing tip. Typically, input from finger 46 and stylus 200 is limited to detection at close range, e.g. up to a distance of 30 mm or 50 mm from touch-screen 10 while input from beam generator 150 can be detected at both a close range and a far range. Optionally, a beam 100 emitted by beam generator 150 can be detected from a distance of up to 1 meter, up to 5 meters or up to 10 meters or more from touch-screen 10.

Typically, digitizer sensor 60 with associated circuitry can simultaneously detect and track position of input received from fingertip 45, stylus 200 and beam 100. Optionally, a cursor or marker on screen 45 follows a detected location of beam 100. In some exemplary embodiments, digitizer sensor 60 can also detect information encoded on the signal emitted by stylus 200 or on beam 100. Optionally, beam generator 150 includes a user selected button 155 that can apply a modulation that emulates mouse selection function or other function. Optionally, the modulation is used for data transfer from beam generator 150 to the digitizer sensor 60.

In some exemplary embodiments, beam generator 150 includes a low power laser diode that emits coherent light in the IR range, e.g. 800 nm-3000 nm wavelength. Optionally, beam generator 150 additionally includes diode emitting in a visible range that can be detected by a user looking that the touch-screen. Optionally, beam generator 150 emits light in the visible range and the visible range is tracked with the digitizer sensor. Typically, on the fly calibration is applied when tracking light in the visible range to differentiate between dose energy received from beam generator 150 and ambient light energy. Beam generator 150 may be included in a laser pointer, a remote control used to operate a television screen or a stylus. Optionally, beam generator 150 can be integrated with stylus 200. Optionally, beam generator 150 radiates a beam from a tail end of stylus 200 opposite the end including the writing tip.

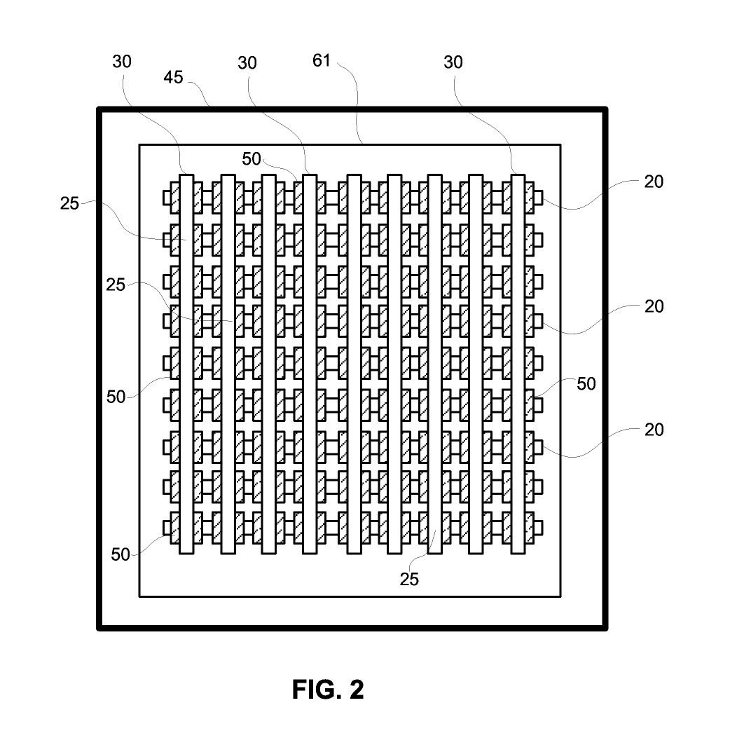

Reference is now made to FIG. 2 showing a simplified schematic drawing of a digitizer sensor including light sensitive material at junction areas between row and column conductive strips in accordance with some embodiments of the present disclosure. In some exemplary embodiments, digitizer sensor 61 is a double layer sensor that includes a first substrate patterned with row antennas 20 overlaid on a second substrate including column antennas 30. Row antennas 20 and column antennas 30 cross to form a grid of junctions 25. Typically, row antennas 20 and column antennas 30 are electrically insulated from one another and each of the antennas is connected at least at on one end to digitizer circuitry. According to some embodiments of the present disclosure, light sensitive material 50 is patterned in junction areas 25 between row antennas 20 and column antennas 30. Optionally, light sensitive material 50 is a photoconductive material that changes its resistivity when radiated by a defined wavelength. Optionally, material 50 is sensitive to wavelength in the IR range between 850 nm to 1500 nm. Alternatively, material 50 is a photovoltaic material that generates a potential when exposed to light at a defined wavelength. Preferably, material 50 is transparent. Optionally, material 50 provides the electrical insulation between the row and column antennas.

A conductive property of material 50 changes when a beam is projected on one or more junctions 25 and the change affects the coupling at the junction(s) that are radiated. Changes in coupling in response to changes in conductive property of material 50 can be detected when applying mutual capacitance detection or self capacitance detection methods. In some exemplary embodiments, material 50 creates a short at a junction that is radiated.

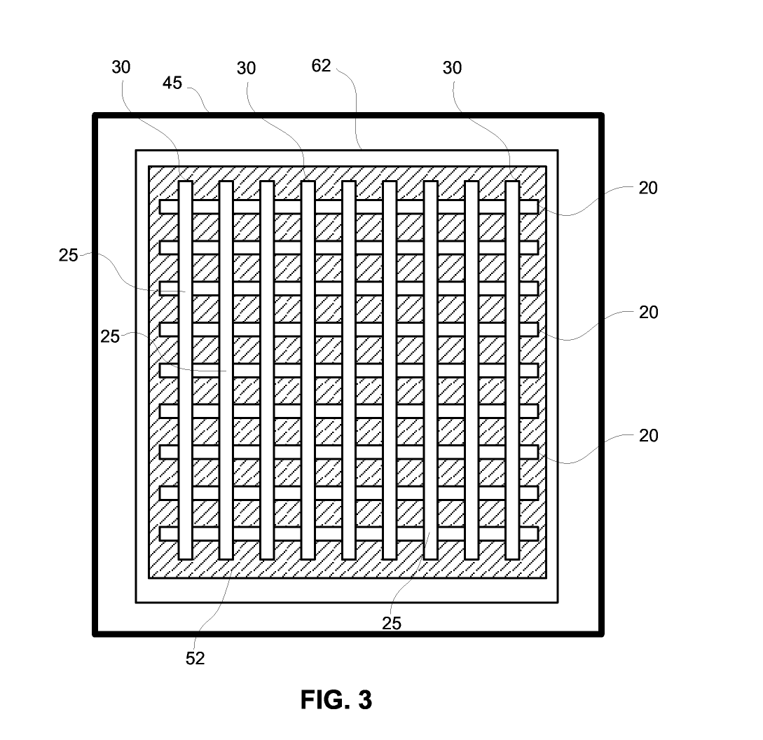

Reference is now made to FIG. 3 showing a simplified schematic drawing of a digitizer sensor including a layer of light sensitive material in accordance with some embodiments of the present disclosure. In some exemplary embodiments, digitizer sensor 62 can be any one of a double layer sensor, a single layer sensor or a single layer sensor with bridge elements. According to some embodiments of the present disclosure, light sensitive material 52 is a continuous layer disposed across digitizer sensor 62. Material 52 may be applied on a surface of sensor 62 that faces display 45, may be applied between a layer including row antennas 20 and a layer including column antennas 30 or may be applied on a surface of sensor 62 that faces a user interaction surface. Preferably, material 52 is transparent so that it does not substantially obstruct display 45. Optionally, a mesh printing process is used to improve transparency of the layer.

According to some exemplary embodiments, a conductive property of material 52 changes locally in response to projected radiation. The change in the conductive property can alter coupling at junctions 25 radiated and can alter coupling between display 45 and sensor 62 in the area that is radiated. Typically, local changes in the conductive property of material 52 can be detected during mutual or self capacitive detection.

In some exemplary embodiments, light sensitive material 52 is a photoconductive material that changes its resistivity when radiated by a defined wavelength. Optionally, material 52 is sensitive to wavelength in the IR range between 850 nm to 1500 nm. Alternatively, material 52 is a photovoltaic material that generates a potential when radiated.

In some exemplary embodiments, material 52 is a photovoltaic material that is operated to accumulate charge for powering a touch enabled device as opposed to tracking location of a beam. In such embodiments, material 52 may be selected to be sensitive to a visible range, e.g. 400 nm to 800 nm that may typically be projected over the entire sensor 62. Any changes in capacitive coupling will typically effect the entire sensor so that the radiation detected will not be confused with interaction and a discrete location.

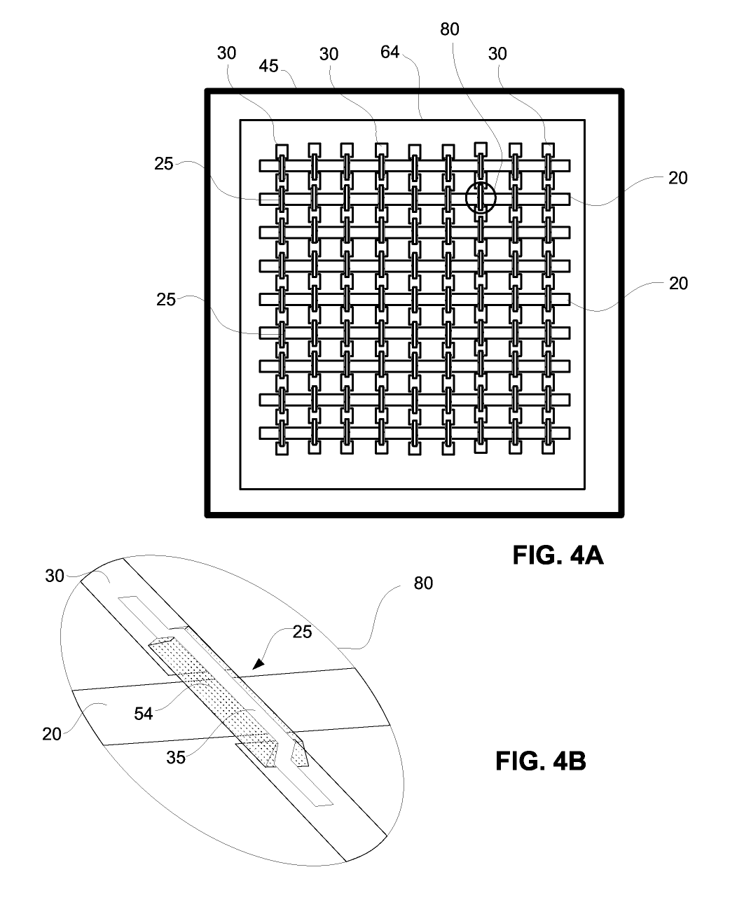

Reference is now made to FIGS. 4A and 4B showing simplified schematic drawings of a digitizer sensor including light sensitive material applied under bridges of the digitizer sensor and a detailed blow up of a bridge area respectively in accordance with some embodiments of the present disclosure. According to some exemplary embodiments, a digitizer sensor 64 is a sensor with a single ITO layer with bridges 35 (shown in blowup 80) that connect segments of column antennas 30 over row antennas 20 at junction areas 25. Typically, in known single layer sensors with bridges, non-conductive material is applied under bridges 35 to provide electrical insulation between row and column antennas at junctions 25. In some exemplary embodiments, light sensitive material 54 is used in place of the insulation that is typically used and material 54 is applied under and optionally around bridges 35.

In some exemplary embodiments, light sensitive material 54 is not transparent to but is small enough so that it does not significantly impair visibility of display 45. In some exemplary embodiments, for a bridge dimension of 10 μm×200 μm, material 54 may have dimensions 200 μm×200 μm and a thickness or height of 0.2-3 μm or 1-3 μm.

Light sensitive material 54 may be a photoconductive material or photodiode material as discussed herein above. In some exemplary embodiments, when one or more junctions 25 are radiated with a beam having a defined wavelength, a change in a conductive property of material 54 occurs and the change affects the capacitive coupling at the junction(s) that are radiated.

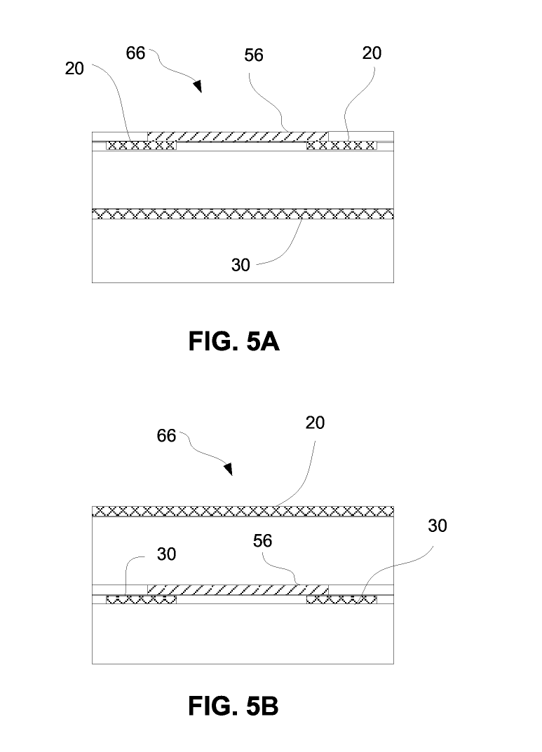

Reference is now made to FIGS. 5A and 5B showing simplified schematic cross sections cut along a column and a row direction respectively of a double layer digitizer sensor in accordance with some exemplary embodiments of the present disclosure. In some exemplary embodiments, a digitizer sensor 66 includes light sensitive material 56 patterned between pairs of row antennas 20 (and pairs of column antennas 30). In some exemplary embodiments, projection of beam on material 56 increases the coupling between parallel antennas 20. Optionally, a short is created between parallel antennas 20 while the beam is projected on material 56. Mutual or self capacitive detection can be applied to detect output on antennas that are contiguous to antennas that are being triggered.

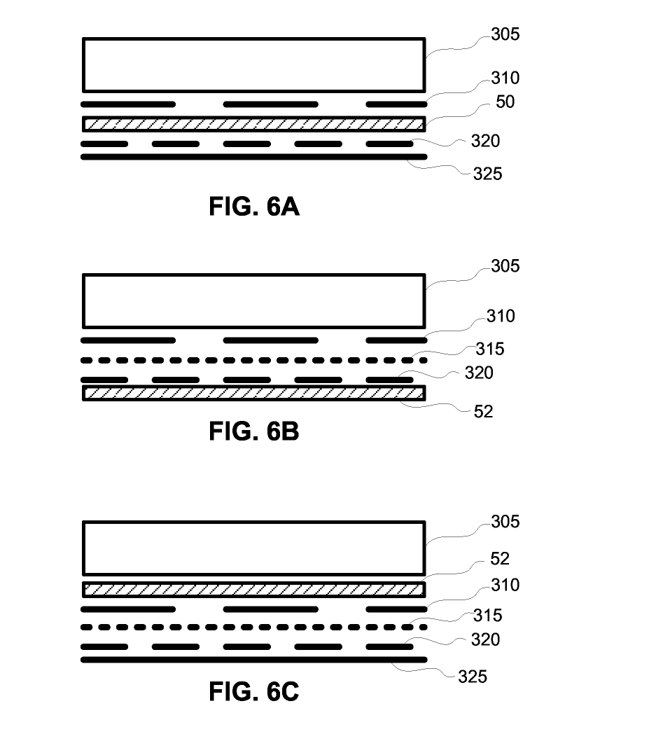

Reference is now made to FIGS. 6A, 6B, 6C, 6D, 6E and 6F showing simplified schematic drawings of exemplary sensor stack in accordance with some embodiments of the present disclosure. According to some exemplary embodiments, a digitizer sensor 60 includes a stackup of layers with light sensitive material 50 integrated as one of the layers in the stackup. Exemplary stackups for single layer ITO sensor with bridges 35 (FIG. 4B) is shown in FIGS. 6A-6D. The stackup typically includes a glass/film substrate 305 over which a user interacts, a ITO layer 310, a isolator layer 315 patterned in junction areas, a metal layer 320 including a pattern of bridges 35 (FIG. 4B) and a passivation layer 325. Passivation layer 325 is typically the layer that is overlaid on digitizer electrodes or antennas (for electrical and mechanical protection).

In some exemplary embodiments, a layer of light sensitive material 54 for sensing interaction with a beam generator is used in place of isolator layer 315 as discussed in reference to FIGS. 4A and 4B. Alternatively, a continuous layer of to material 52 is used in place of passivation layer 325 (FIG. 6B) and activation of material 52 locally increases capacitive coupling between antennas (mutual capacitance). In another exemplary embodiment, material 52 is added between glass/film substrate 305 and ITO layer 310 (FIG. 6C). Another option is to apply light sensitive material 52 on a surface of passivation layer 325 that faces the display 45.

A stackup including light sensitive material for an exemplary single layer ITO sensor that does not include bridges 35 may be similar to the stackup shown in FIGS. 6A-6D but without the metal layer. For single layer digitizer sensors that do not include bridges, light sensitive material 52 can be integrated as a continuous layer between the ITO layer 310 and passivation layer 325 (FIG. 6A), in place of the passivation layer 325 (FIG. 6B), between glass/film substrate 305 and ITO layer 310 (FIG. 6C), or under passivation layer 325 (FIG. 6D). For double layer digitizer sensors shown in FIGS. 6E and 6F, the light sensitive material 50 may be integrated between ITO layers 335 and 340 (FIG. 6E) as shown for example in FIG. 2 or between an optically clear adhesive (OCA) film 330 and a top ITO layer 335 (FIG. 6F). Typically, a separation layer 345 is included between ITO layers 335 and 340.

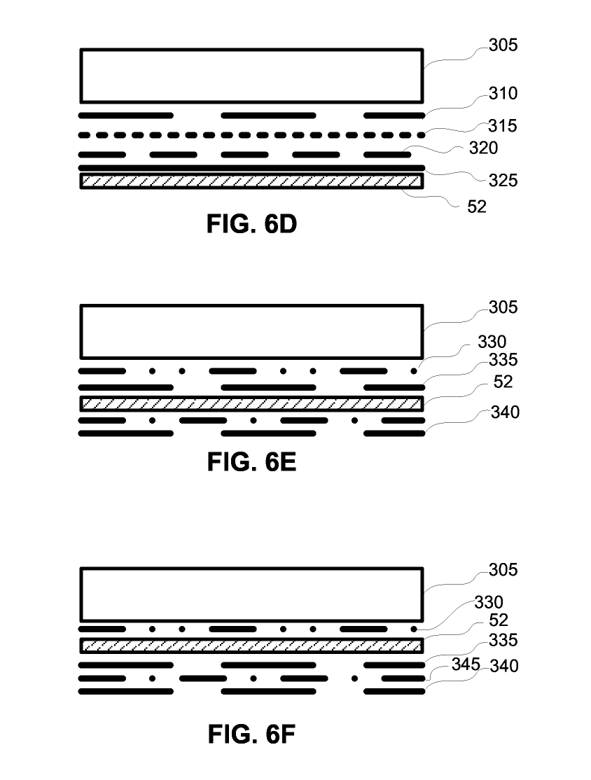

Reference is now made to FIG. 7 showing simplified schematic drawings of exemplary devices that project a beam that can be tracked by a digitizer sensor in accordance with some exemplary embodiments of the present disclosure. Devices 150 and 152 are exemplary devices that are shaped as a stylus and emit a beam 100 from one end of the stylus. Devices 150 may be configured for close range detection, e.g. 0-30 mm from the digitizer sensor or far range detection, e.g. 10 cm-5 m from the digitizer sensor. Typically, shape and power of beam 100 is defined based on the expected distance of interaction and the resolution desired.

Device 152 is an exemplary stylus that emits a signal such as an electric field from one tip 157, e.g. the writing tip of the stylus and radiates a beam of light at a defined wavelength from a tip 158 at an opposite end. Optionally tip 158 can be used to add functionality to a conventional stylus. Optionally, tip 158 can provide erasing functionality or can be configured for remote interaction with a touch-screen, e.g. at distances of 10 cm-1 m.

In some exemplary embodiments, when photoconductive material is used to to track beam 100, parameters of beam 100 are defined based on the following relationship:

ΔR=α·PT·AT/AD Equation (1)

Where:

ΔR is the change in resistance in response to exposure to beam 100;

α is the responsivity of the photoconductive material, e.g. α=7×1010 Ω/W;

PT is the power output of device 150 (or device 152) emitting beam 100, e.g. PT=0.5-1 mW;

AT is the light emitter opening area with diameter of the beam emitted from device 150 (or device 152), e.g. 0.4 mm; and

AD is beam spot area detected when spot diameter of beam 100 projected on the photoconductive material, e.g. 7 mm.

In one exemplary embodiments, when the power output of device 150 is selected to be 0.5 mW and diameter of beam 100 is emitted from an aperture with diameter 0.4 mm, a change in resistance of the photoconductive material will be (7×1010) (0.5×10-3) (π(0.2×10-3)2)/AD=4.4/AD. AD typically depends on the distance between device 150 and the photoconductive material. In one exemplary embodiments, when the beam spot has a diameter is 7 mm, ΔR=114K Ω. If the initial resistance of the photoconductive material is for example 1 M Ω, R=114 K Ω provides 11.5% change resistance due to exposure.

In other exemplary embodiments, when a beam 100 is configured to be detected by a photodiode material, parameters of beam 100 are defined based on the following relationship:

I=ρ·PT·AT/AD Equation (2)

Where:

I is the current output in Amps; and

ρ is the responsivity of the photodiode material, e.g. 0.7 A/W.

In an exemplary embodiments, when the power output of device 150 is selected to be 0.5 mW and diameter of beam 100 is emitted from an aperture with diameter 0.4 mm, current, I generated by the photodiode material will be (0.7) (0.5×10-3) (π(0.2×10-3) 2)/AD=4.4×10-11/AD. In one exemplary embodiments, when AD diameter is 7 mm, I=1.14 μA, which is also significant signal (10-15% to change).

Optionally, devices 150 and 152 include one or more user operated buttons 155 that can be selected to impose a modulation of beam 100 that can be detected by the digitizer sensor. Optionally, beam 100 is a pulsed beam that pulses a defined frequency and modulation of beam 100 is based on ON/OFF pulsing of the beam.

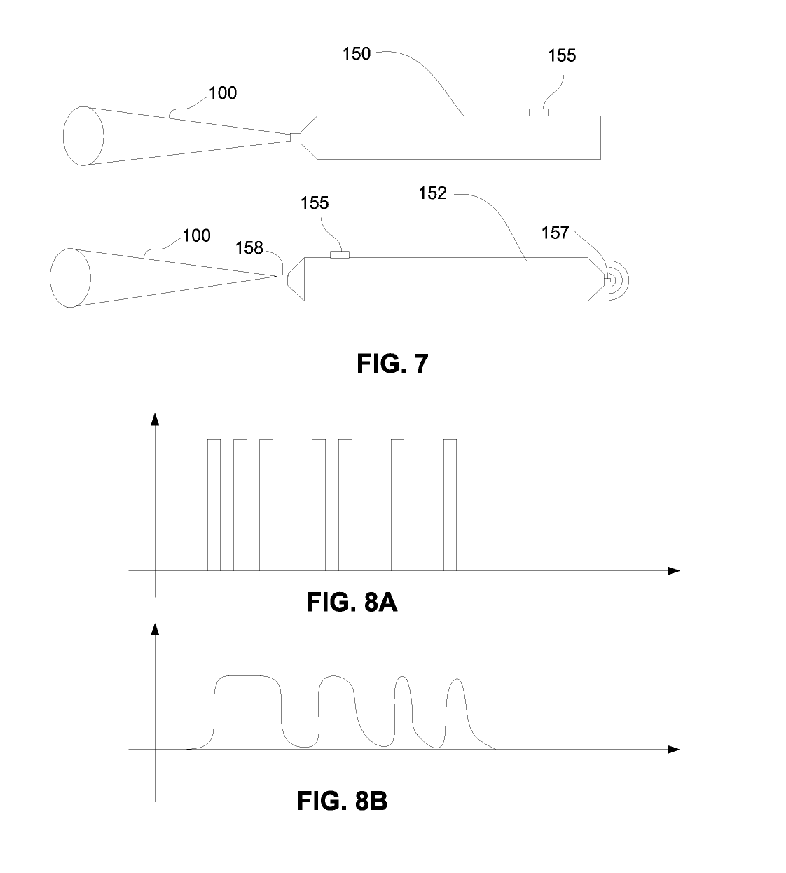

Reference is now made to FIGS. 8A and 8B showing simplified graphs of exemplary modulated beam signal imposed on a digitizer sensor and corresponding output detected in accordance with some embodiments of the present disclosure. According to some embodiments of the present disclosure, beam 100 is pulsed at a pre-defined rate and binary encoding of beam 100 can be imposed by ON/OFF pulsing as shown in FIG. 8A providing an exemplary response shown in FIG. 8B. Typically, output shown in FIG. 8B depends on parameters of the light sensitive material, e.g. response time of the material.

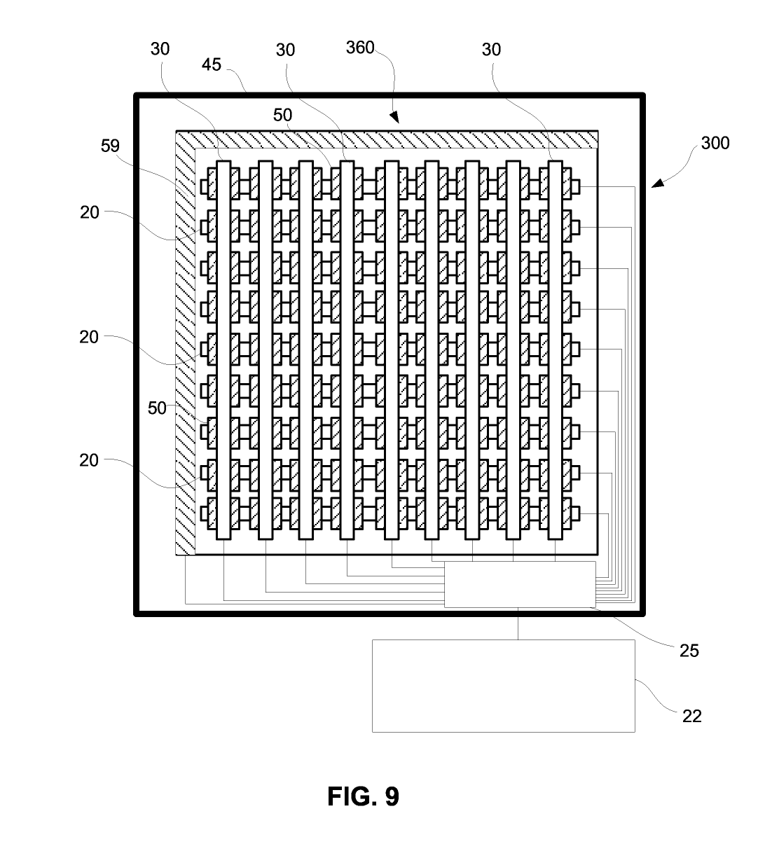

Reference is now made to FIG. 9 showing a simplified schematic drawing of a touch enabled computing device in accordance with some embodiments of the present disclosure. According to some embodiments of the present disclosure, a touch enabled computing device 300 includes digitizer sensor 360 integrated with display 45 (together a touch-screen), a digitizer controller 225 and a host computer 222. Digitizer sensor 360 is a typically a grid based digitizer sensor including row antennas 20 and column antennas 30 arranged to form a grid of junctions. Row antennas 20 and column antennas 30 are typically connected to controller 225. Controller 225 operates to trigger antennas for mutual capacitive or self capacitive detection, to sample output from row and column antennas and to process the output sampled. Typically, controller 225 reports interaction coordinates to host 222.

Optionally, additional information is reported to host 222. Typically, controller 225 detects and tracks coordinates of input from one or more fingers, from a signal emitting stylus and from a beam generator projecting a beam on digitizer sensor 360. In some exemplary embodiments, controller 225 also demodulates information included with the beam generator or on the signal emitted from the stylus.

According to exemplary embodiments, digitizer sensor 360 includes light sensitive material 50 that is configured locally change coupling characteristics of digitizer sensor 360 at locations exposed to radiation. Light sensitive material 50 can be dispersed in discrete areas over sensor 360 or may be a continuous layer extending to over sensor 360. Typically, exposure to a defined wavelength increases capacitive coupling in the area of exposure. Optionally, a short is created between coupled elements of sensor 360 in the area of exposure. Typically, light sensitive material 50 is not connected to controller 225 but rather its affect is detected from output sampled on the antennas.

In some exemplary embodiments, digitizer sensor 360 includes additional light sensitive material 59 that is connected to controller 225. Optionally, light sensitive material 59 is formed from photovoltaic or photodiode material that generates charge when exposed to radiation. Typically, material 59 is also sensitive to a visible range of wavelengths. In some exemplary embodiments, the generated charge is used to power computing device 300.

According to an aspect of some embodiments there is provided a digitizer sensor including a plurality of antennas defining a grid of junctions, wherein the plurality of antennas are configured to sense capacitive coupling at the junctions; and light sensitive material configured to affect capacitive coupling at one or more junctions based on exposure to a beam projected on the digitizer sensor.

Optionally, the light sensitive material is a photo conductive material.

Optionally, the light sensitive material is a photovoltaic material or a photodiode material.

Optionally, the light sensitive material is transparent.

Optionally, the light sensitive material is disposed based on a mesh printing process.

Optionally, the light sensitive material disposed at the junctions.

Optionally, the light sensitive material is a continuous layer across a surface of the digitizer sensor.

Optionally, the sensor includes an ITO layer and a protective layer defining a user interaction surface, wherein the light sensitive material is disposed between an ITO layer and the protective layer.

Optionally, the sensor includes an ITO layer and a protective layer defining a user interaction surface, wherein the protective layer is disposed over the ITO layer and the light sensitive material is disposed under the ITO.

Optionally, the plurality of antennas includes an array of parallel antennas and to wherein the light sensitive material is disposed between parallel antennas of the array.

Optionally, the plurality of antennas includes an array of row antennas and an array of column antennas and wherein the light sensitive material is disposed between pairs the row and the column antennas.

Optionally, the light sensitive material is configured create a short between antennas of the plurality that are exposed to the beam projected.

Optionally, the light sensitive material is sensitive to wavelengths between 800-3000 nm.

Optionally, the light sensitive material is configured to respond to the beam projected from a distance of between 0-10 m.

Optionally, the response time of the light sensitive material is between 0.2 msec-10 msec.

According to an aspect of some embodiments there is provided digitizer sensor including a plurality of antennas defining a grid of junctions, wherein the plurality of antennas are configured to sense capacitive coupling at the junctions; light sensitive material configured to affect output detected at one or more junctions based on exposure to a beam projected on the digitizer sensor; and a circuit configured to sample output from the plurality of antennas and to detect location of the beam on the digitizer sensor based on output.

Optionally, the light sensitive material is configured to affect a capacitive or resistive path between antennas at one or more junctions based on the exposure to the beam projected on the digitizer sensor.

Optionally, the circuit samples output based on a mutual capacitive detection method.

Optionally, the light sensitive material is photovoltaic material that accumulates charge based on exposure to a beam projected on the digitizer sensor and wherein the circuit is configured to power the digitizer system with the charge.

Optionally, the circuit is configured to simultaneously track one or more fingers touching the digitizer sensor and one or more beams projected on the digitizer sensor.

Optionally, the circuit configured to detect and decode modulations imposed on the beam.

Certain features of the examples described herein, which are, for clarity, to described in the context of separate embodiments, may also be provided in combination in a single embodiment. Conversely, various features of the examples described herein, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

What is claimed is:

1. A digitizer sensor comprising:
a plurality of antennas defining a grid of junctions, wherein the plurality of antennas are configured to sense capacitive coupling at the junctions; and
light sensitive material configured to affect capacitive coupling at one or more junctions based on exposure to a beam projected on the digitizer sensor.

2. The digitizer sensor of claim 1, wherein the light sensitive material is a photo conductive material.

3. The digitizer sensor of claim 1, wherein the light sensitive material is a photovoltaic material or a photodiode material.

4. The digitizer sensor of claim 1, wherein the light sensitive material is transparent.

5. The digitizer sensor of claim 1, wherein the light sensitive material is disposed based on a mesh printing process.

6. The digitizer sensor of claim 1, wherein the light sensitive material disposed at the junctions.

7. The digitizer sensor of claim 1, wherein the light sensitive material is a continuous layer across a surface of the digitizer sensor.

8. The digitizer sensor of claim 1, comprising an Indium Tin Oxide (ITO) layer and a protective layer defining a user interaction surface, wherein the light sensitive material is disposed between an ITO layer and the protective layer.

9. The digitizer sensor of claim 1, comprising an ITO layer and a protective layer defining a user interaction surface, wherein the protective layer is disposed over the ITO layer and the light sensitive material is disposed under the ITO.

10. The digitizer sensor of claim 1, wherein the plurality of antennas includes an array of parallel antennas and wherein the light sensitive material is disposed between parallel antennas of the array.

11. The digitizer sensor of claim 1, wherein the plurality of antennas includes an array of row antennas and an array of column antennas and wherein the light sensitive material is disposed between pairs the row and the column antennas.

12. The digitizer sensor of claim 1, wherein the light sensitive material is configured create a short between antennas of the plurality that are exposed to the beam projected.

13. The digitizer sensor of claim 1, wherein the light sensitive material is sensitive to wavelengths between 800-3000 nm.

14. The digitizer sensor of claim 1, wherein the light sensitive material is configured to respond to the beam projected from a distance of between 0-10 m.

15. The digitizer sensor of claim 1, wherein the response time of the light sensitive material is between 0.2 msec-10 msec.

16. A digitizer sensor comprising:
a plurality of antennas defining a grid of junctions, wherein the plurality of antennas are configured to sense capacitive coupling at the junctions;
light sensitive material configured to affect output detected at one or more junctions based on exposure to a beam projected on the digitizer sensor; and
a circuit configured to sample output from the plurality of antennas and to detect location of the beam on the digitizer sensor based on output.

17. The digitizer sensor of claim 16, wherein the light sensitive material is configured to affect a capacitive or resistive path between antennas at one or more junctions based on the exposure to the beam projected on the digitizer sensor.

18. The digitizer system of claim 16, wherein the circuit samples output based on a mutual capacitive detection method.

19. The digitizer system of claim 16, wherein the light sensitive material is photovoltaic material that accumulates charge based on exposure to a beam projected on the digitizer sensor and wherein the circuit is configured to power the digitizer system with the charge.

20. The digitizer system of claim 16, wherein the circuit is configured to simultaneously track one or more fingers touching the digitizer sensor and one or more beams projected on the digitizer sensor.

21. The digitizer system of claim 16, wherein the circuit configured to detect and decode modulations imposed on the beam.
